(19) United States
(12) Patent Application Publication
(10) Pub. No.: US 2018/0354117 A1
(43) Pub. Date: Dec. 13, 2018

(54) PNEUMATIC ROTARY HAND TOOL WITH ROTATING IMPACT KINETIC ENERGY

(71) Applicant: DE POAN PNEUMATIC CORP., New Taipei City (TW)

(72) Inventors: I-TSUNG WU, NEW TAIPEI CITY (TW); YI-WEI WEN, NEW TAIPEI CITY (TW); SHUN-YAO YANG, NEW TAIPEI CITY (TW)

(21) Appl. No.: 15/997,697

(22) Filed: Jun. 5, 2018

(30) Foreign Application Priority Data
Jun. 13, 2017 (TW) 106119607

(51) Int. Cl. B25F 5/00; B25B 21/02

(52) U.S. Cl. CPC B25F 5/001; B25B 21/02

(57) ABSTRACT

The present invention provides a pneumatic hand tool with rotating impact kinetic energy comprising a pneumatic motor arranged inside a device case. The pneumatic motor is pivotally connected with a first axial bevel gear. An ending portion of the device case is pivotally connected with an impact power set. The impact power set is integrally formed to form a second axial bevel gear, and the second axial bevel gear and the first axial bevel gear are in mesh. The problem of abrasion of the conventional percussion power group improved during in the process of transmitting rotation force together with striking force is easily solved.

### FIELD OF THE INVENTION

The present invention relates to a pneumatic hand tool for rotation locking an item, and more particularly to a pneumatic hand tool with rotating impact kinetic energy.

### PRIOR ARTS OF THE INVENTION

It is well known that pneumatic hand tools relying on high pressure air as a power source can generally be distinguished as a linear motion tool and a pneumatic rotary tool. In the pneumatic rotary tool according to the present invention, a pneumatic motor is disposed inside the tool body for receiving the high pressure air to generate the rotational kinetic energy output.

Pneumatic hand tools conventionally equipped with a pneumatic motor can be widely used in pneumatic screwdrivers used for screwing and disassembling screws, or in pneumatic wrenches used for twisting and disassembling nuts or bolts. Among them, pneumatic wrenches used for screw-locking and disassembling a nut or a bolt often output a knocking kinetic energy in the process of outputting rotational kinetic energy.

Pneumatic hand tools traditionally accompanied by rotary percussive kinetic energy can be found in, for example, the patented technology of US Patent Application No. 2013/0233585. The percussive kinetic energy relies on the output end of the pneumatic motor of the hand tool configured with an impact set. The structure technology of the impact set can be found in the patented technology of Taiwan Patent No. M501340U to reveal its functional principle.

In general, the impact kinetic energy enables the pneumatic motor to output an intermittent knocking force in accordance with its circumferential rotation path during rotation of the output kinetic energy of the pneumatic motor, so as to facilitate the tight engagement effect between the threads during locking of the nut or the bolt by the force of engagement, and to facilitate the engagement between the threads accelerated by the force when the nut or bolt is disassembled.

Please refer to FIG. 1. It is disclosed that the above-mentioned US Patent Application No. 2013/0233585 teaches that the pneumatic motor 200 output shaft axially engages a first axial bevel gear 201, and the first axial bevel gear 201 engages with a second axial bevel gear 202. An impact power set 300 are pivotally connected to the center of the second axial bevel gear 202. The impact power set 300 includes an output rotation shaft 303 and an impact ring 302 disposed on the output rotation shaft 303. The periphery of the impact ring 302 is further provided with a rotary seat 301 for rotating the rotation shaft 303, and a nut head 304 formed at one end of the rotary seat 301 is engaged with the center of the second axial bevel gear 202.

Accordingly, the rotation kinetic energy output by the pneumatic motor 200 sequentially drives the rotary seat 301 to rotate via the first axial bevel gear 201 and the second axial bevel gear 202. The rotary seat 301 which rotates during the rotation can drive the impact ring 302 to rotate together in a pivot manner of a specific track, and the impact ring 302 is rotated and hits once in a specific track and intermittently impacts the output rotation shaft 303 so that the output rotation shaft 303 rotates. The output rotation shaft 303 can also produce intermittent tapping forces during the output of rotational kinetic energy.

However, since the rotation between the second axial bevel gear 202 and the rotary seat 301 must be transferred by and depend on the engagement of the nut head 304, it is easier to cause wear of the embedding position, to impair the transmission of power and even to affect the durable service life of the tool during of the forward and reverse (reverse force) transmission by the rotation force together with the impact incidental tapping force.

### SUMMARY OF THE INVENTION

The present invention aims to reduce the amount of parts of a pneumatic hand tool, and to improve the mutual fitting position of the bevel gear and the impact power set, and it is not easy to generate a problem of abrasion in the process of transmitting the rotating incidental hammering force.

According to a preferred embodiment of the present invention, there is provided a pneumatic hand tool with rotating impact kinetic energy comprising:

a device case equipped with a pneumatic motor inside;

a first axial bevel gear axially connected to an axis of the pneumatic motor and located at one ending portion of the device case; and

an impact power set comprising
a rotary seat being in the form of a ring seat and pivotally connected to the ending portion of the device case, the rotary seat being integrally formed with a second axial bevel gear and a receiving chamber, the second axial bevel gear and the first axial bevel gear being engaged with each other, and the receiving chamber being formed inside the rotary seat;
at least one impact ring accommodated in the receiving chamber, a path hole being formed inside the impact ring, and the impact ring being constrained by the rotation of the rotary seat to move and rotate; and
an output rotation shaft formed with a shaft joint of an output power at one end, the output rotation shaft penetrating through the path hole of the impact ring to pivotally connect with the rotary seat, the shaft joint being exposed to the rotary seat, at the outer end, and the output rotation shaft receiving the intermittent tapping of the impact ring to output rotational knocking kinetic energy from the shaft joint.

More specifically, the above technical features can be further implemented as follows: The rotary seat has a top portion and a bottom portion in the same axial direction, the second axial bevel gear is formed on the top portion, the shaft joint is protruded from and exposed at the outer end of the bottom portion, the top portion is located at the ending portion of the device case, the bottom portion is relatively far from the ending portion of the device case, and the receiving chamber is located between the top portion and the bottom portion.

According to the present invention, preferably the two end walls of the rotary seat respectively form an opening, and the opening communicates with the receiving chamber.

According to the present invention, preferably at least one shaft bolt is mounted in the rotary seat, at least one arc groove is formed on the outer wall of the impact ring, the shaft bolt extends into the receiving chamber to contact the arc groove and the impact ring is constrained to move and rotate.

According to the present invention, preferably at least one protruding portion is formed on a hole wall of the path hole, at least one protruding rib is formed on a shaft wall of the output rotation shaft, and for the impact ring the protruding portion strikes the protruding rib to output rotary tapping kinetic energy from the shaft joint of the output rotation shaft.

According to the present invention, preferably a plurality of impact rings are disposed in the receiving chamber, the amount of protruding ribs formed on the output rotation shaft is equal to the amount of impact rings disposed, and the plurality of impact rings receive the output rotation shaft penetrating through in series.

According to the above, the technical effect of the present invention is that the second axial bevel gear is integrally formed on the rotary seat of the impact power set, in addition to reducing the amount of parts of the pneumatic hand tool, it can improve the problem that the bevel gear is prone to wear during the transmission of the rotating incidental hammering force.

In addition, another embodiment of the present invention also provides a pneumatic hand tool with rotating impact kinetic energy comprising:

a device case equipped with a pneumatic motor inside;

a first axial bevel gear axially connected to an axis of the pneumatic motor and located at one ending portion of the device case; and

an impact power set comprising
a rotary seat having an annular outer wall and an inner receiving chamber, the rotary seat being integrally extended to form a second axial bevel gear, the rotary seat being pivotally connected to an ending portion of the device case, the second axial bevel gear being meshed with the first axial bevel gear, at least one passing slot communicated with the receiving chamber being formed on the annular outer wall, and a post being movably arranged in the passing slot;
an impact ring formed in a sleeve shape and having an annular inner wall, the impact ring being pivotally mounted on the annular outer wall of the rotary seat via the annular inner wall, at least one arc groove being formed on the annular inner wall, the post being guided by the arc groove and the annular inner wall of the impact ring and is capable of being intermittently moved into the receiving chamber via the passing slot intermittently so as to drive the impact ring to rotate and being restricted by the rotation and movement of rotary seat; and
an output rotation shaft formed with a shaft joint for outputting power at one end thereof, the output rotation shaft being inserted into the receiving chamber and being pivotally connected with the rotary seat so that the shaft joint is exposed to the outer end of the rotary seat, at least one protruding rib being formed on a shaft wall of the output rotation shaft, and the protruding rib receiving the knocking of the post partially moved into the receiving chamber so that the shaft joint of the output rotation shaft outputs rotational percussion kinetic energy.

More specifically, the above technical features can be further implemented as follows: The rotary seat has a top portion and a bottom portion in the same axial direction, the second axial bevel gear is formed on the top portion, the shaft joint is exposed at the outer end of the bottom portion, the top portion is located at the ending portion of the device case, the bottom portion is relatively far from the ending portion of the device case, and the receiving chamber is located between the top portion and the bottom portion.

According to the present invention, preferably the bottom portion of the rotary seat forms an opening communicating with the receiving chamber, and the output rotation shaft is implanted into the receiving chamber via the opening.

The technical means of the method and apparatus described above and the specific implementation details of their performance can be described with reference to the following examples and drawings.

### BRIEF DESCRIPTION OF THE DRAWINGS

FIG. 1 is an exploded perspective view of a conventional pneumatic hand tool;

FIG. 2 is an exploded perspective view of the pneumatic hand tool of the present invention;

FIG. 3 is a cross-sectional view of the pneumatic hand tool of the present invention after combination of FIG. 2;

FIG. 4a is a cross-sectional view of a first embodiment of an impact power set in the present invention;

FIG. 4b is a cross-sectional view of the A-A section of FIG. 4a of the present invention;

FIG. 5a is a cross-sectional view of a second embodiment of an impact power set in the present invention;

FIG. 5b is a cross-sectional view of the B-B section of FIG. 5a of the present invention;

FIG. 6a is a cross-sectional view of a third embodiment of an impact power set in the present invention;

FIG. 6b is a cross-sectional view of the C-C section of FIG. 6a of the present invention;

FIGS. 7a to 7f are schematic diagrams of the operation of FIG. 6b of the present invention respectively.

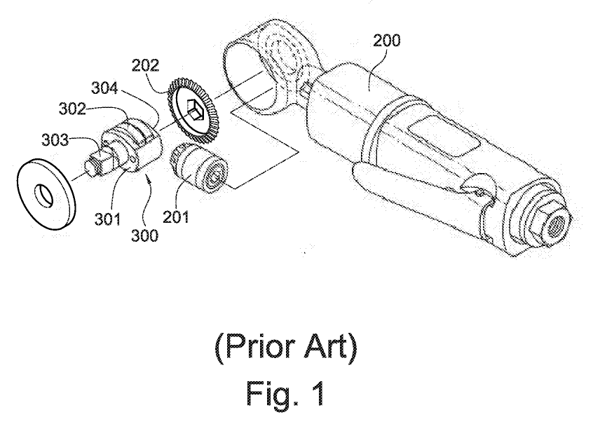

### DETAILED DESCRIPTION OF THE INVENTION

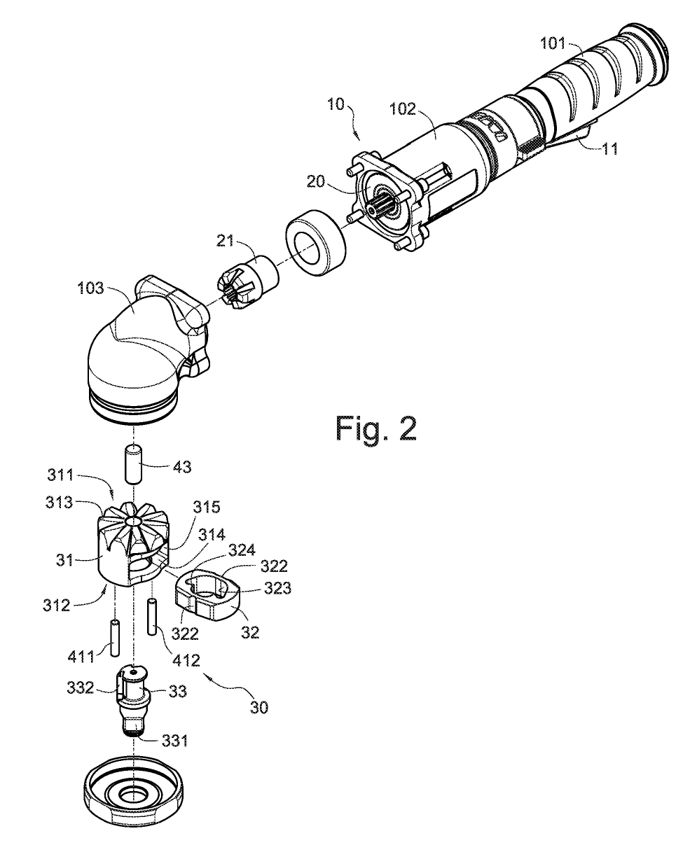

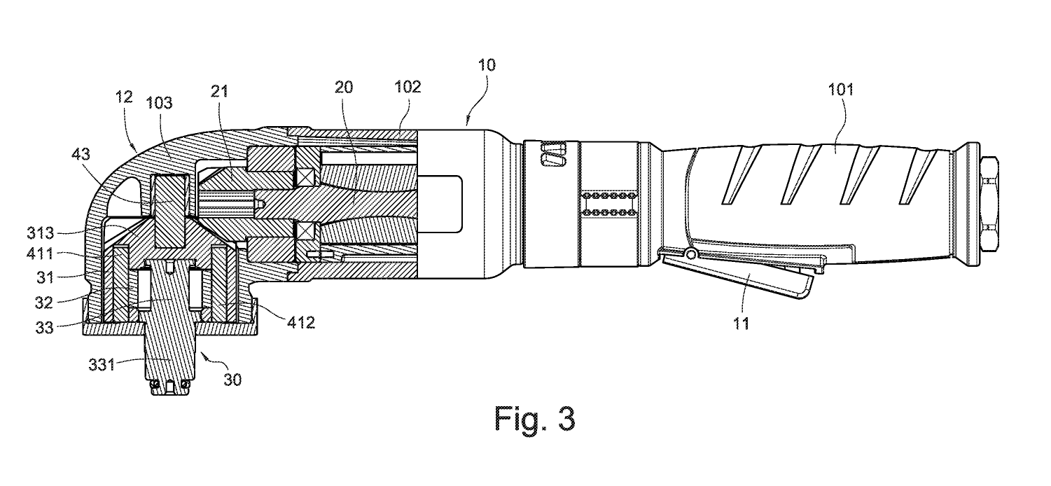

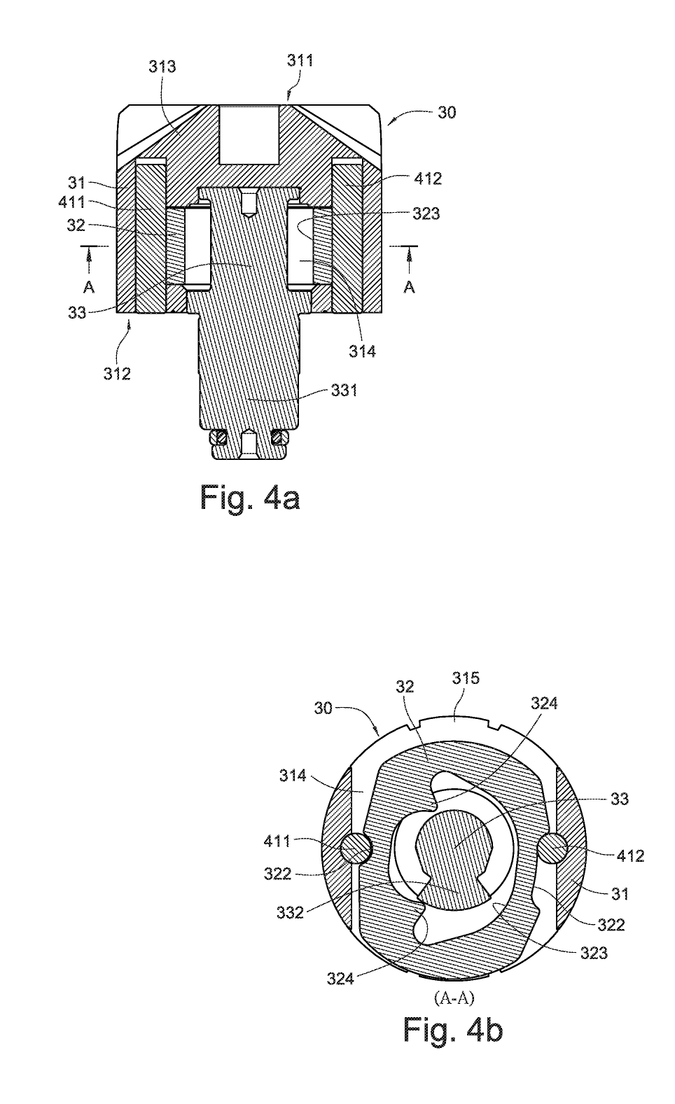

Firstly, please refer to FIG. 2 to FIG. 4b to disclose the first embodiment of the present invention illustrating the pneumatic hand tool with rotating impact kinetic energy provided by the present invention including a device case 10, a first axial bevel gear 21 and an impact power set 30.

The device case 10 is in the shape of a hollow shell. The device case 10 is implemented by a series connection of a handle housing 101, a motor housing 102 and a head housing 103. A pneumatic motor 20 is fixed in the motor housing 102 of the device case 10. A gas flow passage (not shown) for guiding high-pressure air is disposed in the handle housing 101 of the device case 10. On a side wall surface of the handle housing 101, a push-button switch 11 which can be pressed and released by the operator by hand is provided. When the operator presses the push-button switch 11, the high-pressure air can be introduced into the gas flow path to drive the pneumatic motor 20. Further, the first axial bevel gear 21 is axially connected to the axis of the pneumatic motor 20 and is located at one ending portion 12 of the device case 10. More specifically, the first axial bevel gear 21 is located within the head housing 103 of the device case 10.

The impact power set 30 comprises a rotary seat 31, at least one impact ring 32, and an output rotation shaft 33. The rotary seat 31 is in the form of a ring seat, and the rotary seat 31 passes through the head housing 103. A bolt member 43 is pivotally connected to the ending portion 12 of the device case 10, and the rotary seat 31 is extended and integrally forms a second axial bevel gear 313. The bolt member 43 is pivotally connected to an axis of the second axial bevel gear 313 so that the second axial bevel gear 313 meshes with the first axial bevel gear 21. A receiving chamber 314 is formed inside the rotary seat 31. Further, the rotary seat 31 has a top portion 311 and a bottom portion 312 in the same axial direction. The second axial bevel gear 313 is formed on the top portion 311. The top portion 311 is located on the ending portion 12 of the device case 10, i.e., in the head housing 103. The bottom portion 312 is relatively far from the ending portion 12 of the device case 10, and the receiving chamber 314 is located between the top portion 311 and the bottom portion 312. In addition, the axial direction of the first axial bevel gear 21 and the axial direction of the second axial bevel gear 313 are perpendicular to each other.

The impact ring 32 is accommodated in the receiving chamber 314. A path hole 323 is formed inside the impact ring 32. At least one arc groove 322 is formed on the outer wall of the impact ring 32. Further, the two end walls of the rotary seat 31 are respectively formed with an opening 315 communicating with the receiving chamber 314. The impact ring 32 is received in the receiving chamber 314 through the opening 315. At least one shaft bolt 411, 412 is mounted in the rotary seat 31. The shaft bolts 411, 412 penetrate into the receiving chamber 314 and contacts the arc groove 322 so as to confine the impact ring 32 to move and rotate. In this embodiment, the amount of the impact ring is one.

An shaft joint 331 for outputting power is formed at one end of the output rotation shaft 33. The output rotation shaft 33 penetrates through the path hole 323 of the impact ring 32 to pivotally connect with the rotary seat 31, and the extension of the shaft joint 331 is exposed to the outer end of the bottom portion 312 of the rotary seat 31, and the output rotation shaft 33 is driven and rotated by the movement and rotation of the rotary seat 31. Further, at least one protruding rib 332 is formed on a shaft wall of the output rotation shaft 33. At least one protruding portion 324 is formed on the hole wall of the path hole 323 of the impact ring 32. The impact ring 32 strikes the protruding rib 332 via the protruding portion 324 to cause the shaft joint 331 of the output rotation shaft 31 to output rotational knocking kinetic energy.

By the above, the rotary kinetic energy output from the pneumatic motor 20 sequentially drives the rotary seat 31 to rotate through the first axial bevel gear 21 and the second axial bevel gear 313. The rotary seat 31 can drive the output rotation shaft 33 to output the rotating kinetic energy, and the rotary seat 31 can drive the impact ring 32 to rotate together in a pivot manner of a specific trajectory during the rotation. The impact ring 32 rotates once in a specific trajectory and once in one cycle, intermittently so that the output rotation shaft 33 is impacted so that the output rotation shaft 33 can generate an intermittent tapping force during the output of rotational kinetic energy. In addition, the manner in which the output rotation shaft 33 receives the intermittent tapping of the impact ring 32 and outputs the kinetic energy of the rotary strike in the impact power set 30 has been fully disclosed in the aforementioned patent application, and therefore will not be described again.

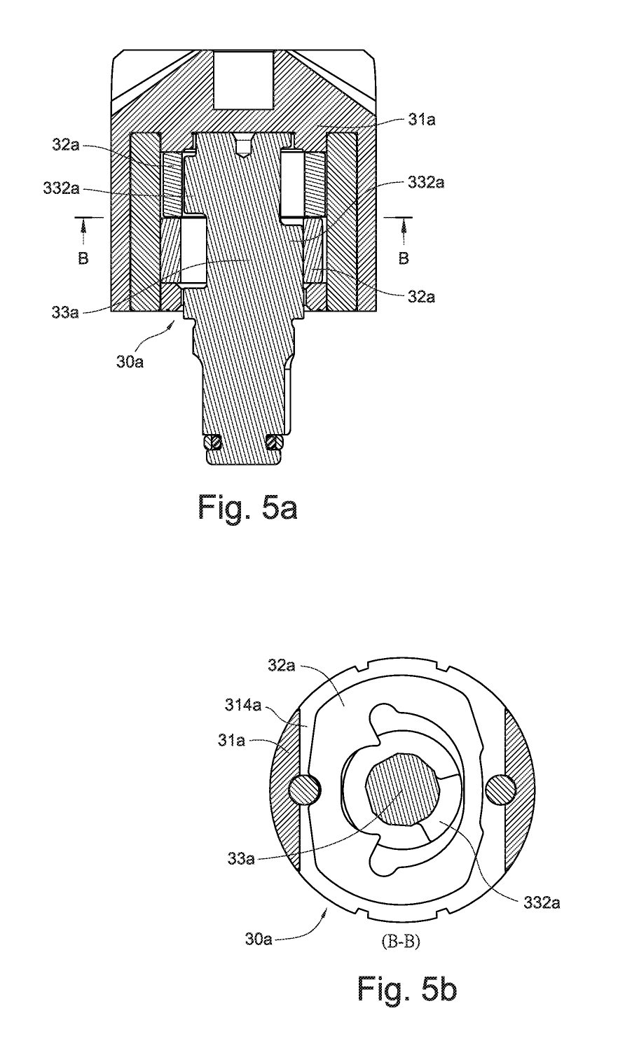

Further, please refer to FIG. 5a and FIG. 5b together to illustrate a second embodiment of the present invention, to illustrate a pneumatic hand tool with rotating impact kinetic energy provided by the present invention, wherein the present embodiment The difference from the first embodiment is as follows:

The amount of the impact rings 32a accommodated in the receiving chamber 314a of the rotary seat 31a in the impact power set 30a is plural, and the amount of the protruding ribs 332a formed on the output rotation shaft 33a is the same as the amount of the impact ring 32a disposed. The plurality of impact rings 32a receive and pass through the output rotation shaft 33a in an in-series manner. The amount of the impact ring 32a and the protruding rib 332a are respectively two in implementation. Further, the angle between the two protruding ribs 332a formed on the output rotation shaft 33a is 180 degrees, and when the two impact rings 32a make one revolution with a specific trajectory, the two impact rings 32a intermittently impact once upon the output rotation shaft 33a. The two impact rings 32a simultaneously impact the output rotation shaft 33a.

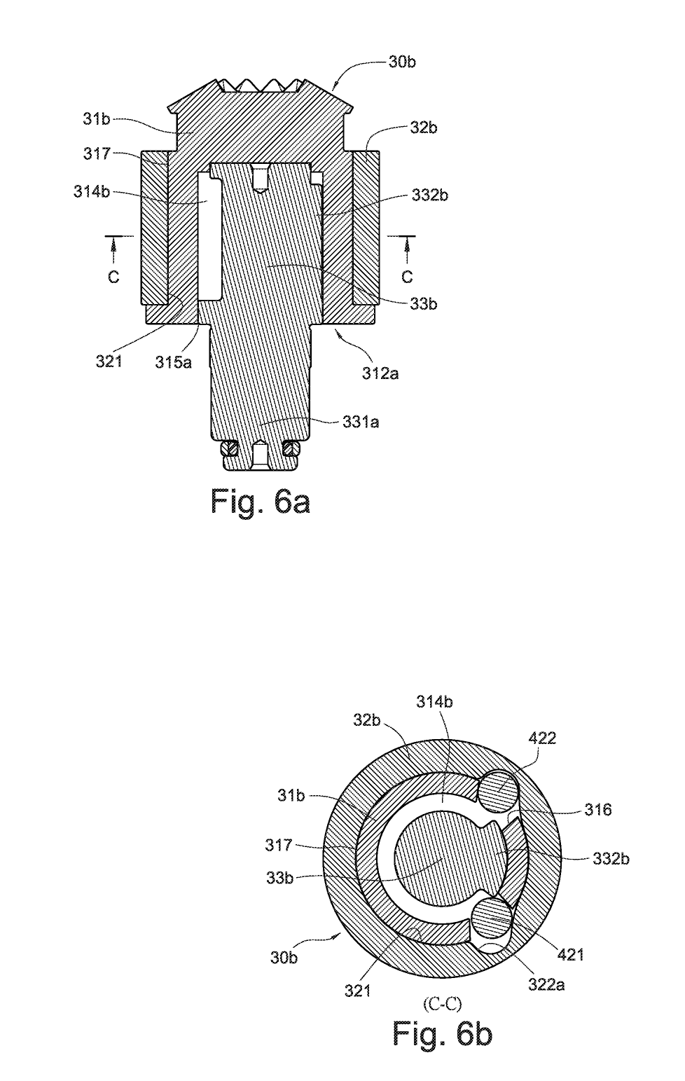

Please refer to FIG. 6a and FIG. 6b again to disclose the third embodiment of the present invention, and to illustrate the pneumatic hand tool with rotating impact kinetic energy provided by the present invention, wherein the difference between the present embodiment and the first embodiment and the second embodiment are as follows:

The rotary seat 31b in the impact power set 30b has an annular outer wall 317 and an inner receiving chamber 314b, and the annular outer wall 317 is formed with at least one passing slot 316 communicating with the receiving chamber 314b. The amount of passing slots 316 is two in practice, and at the bottom portion 312a of the rotary seat 31b an opening 315a that communicates with the receiving chamber 314b is formed. Further, a post 421, 422 is disposed in the two passing slots 316 respectively.

The impact ring 32b is in the form of a sleeve. The impact ring 32b is formed with an annular inner wall 321. The impact ring 32b is pivotally mounted on the annular outer wall 317 of the rotary seat 31b via the annular inner wall 321. The annular inner wall 321 is formed with at least one arc groove 322a. The amount of the arc grooves 322a is two in implementation. The posts 421 and 422 are guided by the arc groove 322a and the annular inner wall 321 of the impact ring 32b to be capable of being intermittently moved into the receiving chamber 314b through the passing slot 316 so as to drive the impact ring 32b to rotate and move under the restriction of rotation of the rotary seat 31b.

The output rotation shaft 33b is inserted into the receiving chamber 314b through the opening 315a and pivotally connected to the rotary seat 31b. The protruding rib 332b of the output rotation shaft 33b can receive the knocking of the posts 421, 422 which partially moved into the receiving chamber 314b to cause the shaft joint 331a of the output rotation shaft 33b to output rotary hammering kinetic energy.

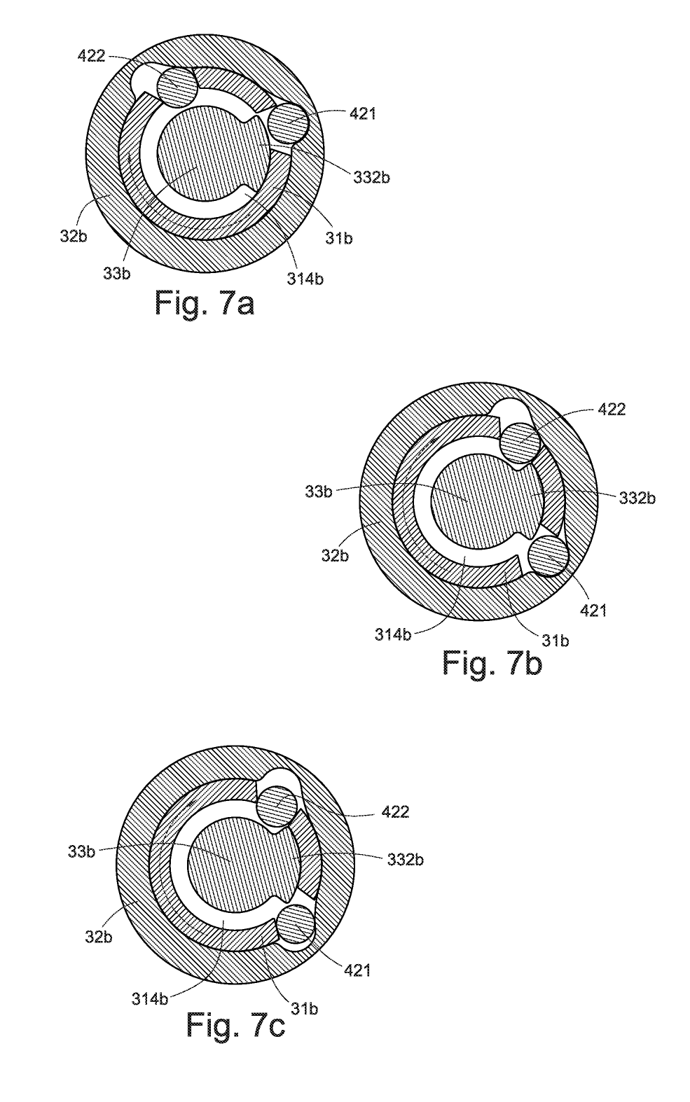

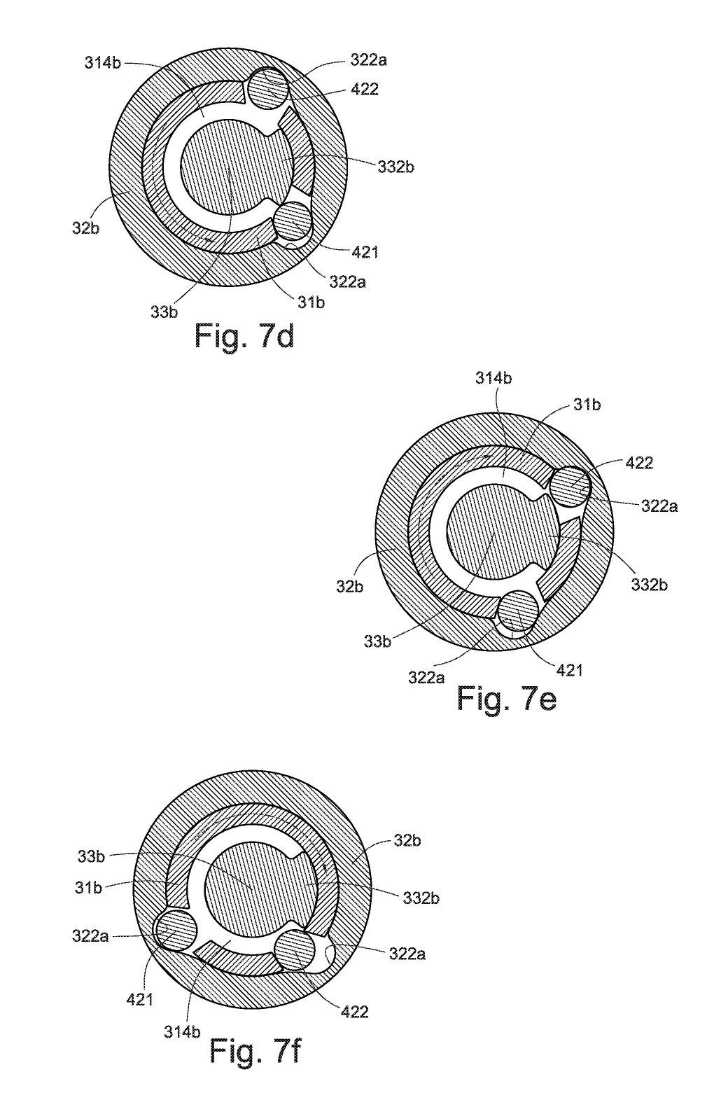

By the above, when the rotary seat 31b is driven to rotate in the clockwise direction when the pneumatic motor 20 is driven, the rotary seat 31b can drive the impact ring 32b and the posts 421, 422 to follow the rotation (As shown in FIG. 7a). The post 422 stops moving by contacting the protruding rib 332b of the output rotation shaft 33b during the rotation (as shown in FIG. 7b), and the rotary seat 31b stops moving along with the impact ring 32b will continue to rotate due to its inertia. When the impact ring 32b continues to rotate in the clockwise direction (as shown in FIG. 7c), the impact ring 32b will push the post 421 to impact against the rotary seat 31b, so that the rotary seat 31 is associated with the post 422 to knock the protruding rib 332b of the output rotation shaft 33b. When the post 422 strikes the protruding rib 332b of the output rotation shaft 33b (as shown in FIG. 7d), the rotary seat 31b receives a reverse force via the post 422 to reversely rotate so that the posts 421 and 422 move to the arc groove 322a and away from the receiving chamber 314b. Then, the rotary seat 31b drives the impact ring 32b and the posts 421 and 422 to continue to rotate in the clockwise direction (as shown in FIG. 7e). After the post 422 passes through the protruding rib 332b of the output rotation shaft 33b, the post 422 is pushed by the rotary seat 31b and is guided by the arc groove 322a to partially move into the receiving chamber 314b (as shown in FIG. 7f). The post 421 abuts against the arc groove 322a due to the centrifugal force during the rotation and receives the driving of the rotary seat 31b to continue to rotate in the clockwise direction, the operation of striking the protruding rib 332b of the output rotation shaft 33b is completed. On the other hand, when the rotary seat 31b is driven by the pneumatic motor 20 to rotate in the counterclockwise direction, the operating modes of the posts 421, 422 are interchanged, that is, the post 421 performs the action of striking the protruding rib 332b of the output rotation shaft 33b.

The above embodiments are merely preferred embodiments for expressing the present invention, but they should not be construed as limiting the scope of the present invention. Therefore, the present invention shall be subject to the content of the claims defined in the scope of the patent application.

We claim:

1. A pneumatic hand tool with rotating impact kinetic energy comprising:
a device case equipped with a pneumatic motor inside;
a first axial bevel gear axially connected to an axis of the pneumatic motor and located at one ending portion of the device case; and
an impact power set comprising
a rotary seat being in the form of a ring seat and pivotally connected to the ending portion of the device case, the rotary seat being integrally formed with a second axial bevel gear and a receiving chamber, the second axial bevel gear and the first axial bevel gear being engaged with each other, and the receiving chamber being formed inside the rotary seat;
at least one impact ring accommodated in the receiving chamber, a path hole being formed inside the impact ring, and the impact ring being constrained by the rotation of the rotary seat to move and rotate; and
an output rotation shaft formed with a shaft joint of an output power at one end, the output rotation shaft penetrating through the path hole of the impact ring to pivotally connect with the rotary seat, the shaft joint being exposed to the rotary seat, at the outer end, and the output rotation shaft receiving the intermittent tapping of the impact ring to output rotational knocking kinetic energy from the shaft joint.

2. The pneumatic hand tool with rotating impact kinetic energy as claimed in claim 1, wherein the rotary seat has a top portion and a bottom portion in the same axial direction, the second axial bevel gear is formed on the top portion, the shaft joint is protruded from and exposed at the outer end of the bottom portion, the top portion is located at the ending portion of the device case, the bottom portion is relatively far from the ending portion of the device case, and the receiving chamber is located between the top portion and the bottom portion.

3. The pneumatic hand tool with rotating impact kinetic energy as claimed in claim 1, wherein the two end walls of the rotary seat respectively form an opening, and the opening communicates with the receiving chamber.

4. The pneumatic hand tool with rotating impact kinetic energy as claimed in claim 1, wherein at least one shaft bolt is mounted in the rotary seat, at least one arc groove is formed on the outer wall of the impact ring, the shaft bolt extends into the receiving chamber to contact the arc groove and the impact ring is constrained to move and rotate.

5. The pneumatic hand tool with rotating impact kinetic energy as claimed in claim 4, wherein at least one protruding portion is formed on a hole wall of the path hole, at least one protruding rib is formed on a shaft wall of the output rotation shaft, and for the impact ring the protruding portion strikes the protruding rib to output rotary tapping kinetic energy from the shaft joint of the output rotation shaft.

6. The pneumatic hand tool with rotating impact kinetic energy as claimed in claim 5, wherein a plurality of impact rings are disposed in the receiving chamber, the amount of protruding ribs formed on the output rotation shaft is equal to the amount of impact rings disposed, and the plurality of impact rings receive the output rotation shaft penetrating through in series.

7. A pneumatic hand tool with rotating impact kinetic energy comprising:
a device case equipped with a pneumatic motor inside;
a first axial bevel gear axially connected to an axis of the pneumatic motor and located at one ending portion of the device case; and
an impact power set comprising
a rotary seat having an annular outer wall and an inner receiving chamber, the rotary seat being integrally extended to form a second axial bevel gear, the rotary seat being pivotally connected to an ending portion of the device case, the second axial bevel gear being meshed with the first axial bevel gear, at least one passing slot communicated with the receiving chamber being formed on the annular outer wall, and a post being movably arranged in the passing slot;
an impact ring formed in a sleeve shape and having an annular inner wall, the impact ring being pivotally mounted on the annular outer wall of the rotary seat via the annular inner wall, at least one arc groove being formed on the annular inner wall, the post being guided by the arc groove and the annular inner wall of the impact ring and is capable of being intermittently moved into the receiving chamber via the passing slot intermittently so as to drive the impact ring to rotate and being restricted by the rotation and movement of rotary seat; and
an output rotation shaft formed with a shaft joint for outputting power at one end thereof, the output rotation shaft being inserted into the receiving chamber and being pivotally connected with the rotary seat so that the shaft joint is exposed to the outer end of the rotary seat, at least one protruding rib being formed on a shaft wall of the output rotation shaft, and the protruding rib receiving the knocking of the post partially moved into the receiving chamber so that the shaft joint of the output rotation shaft outputs rotational percussion kinetic energy.

8. A pneumatic hand tool with rotating impact kinetic energy as claimed in claim 7, wherein the rotary seat has a top portion and a bottom portion in the same axial direction, the second axial bevel gear is formed on the top portion, the shaft joint is exposed at the outer end of the bottom portion, the top portion is located at the ending portion of the device case, the bottom portion is relatively far from the ending portion of the device case, and the receiving chamber is located between the top portion and the bottom portion.

9. The pneumatic hand tool with rotating impact kinetic energy as claimed in claim 7, wherein the bottom portion of the rotary seat forms an opening communicating with the receiving chamber, and the output rotation shaft is implanted into the receiving chamber via the opening.
